(19) United States
(12) Patent Application Publication
(10) Pub. No.: US 2012/0069037 A1
(43) Pub. Date: Mar. 22, 2012

(54) RESOLUTION INDEPENDENT RENDERING OF QUADRATIC BEZIER CURVES USING PROGRAMMABLE GRAPHICS HARDWARE

(75) Inventor: Gerard Ziemski, North Platte, NE (US)

(73) Assignee: ORACLE AMERICA, INC., Redwood City, CA (US)

(21) Appl. No.: 12/887,324

(22) Filed: Sep. 21, 2010

(51) Int. Cl. G06T 11/00

(52) U.S. Cl. 345/586

(57) ABSTRACT

A computer system, program, and method for resolution-independent rendering of an image defined at least in part by a Bezier curve function includes subdividing the image into a plurality of polygons based on Bezier control points of the Bezier curve function, each of the polygons being defined around a Bezier curve, assigning texture coordinates to the Bezier control points, projecting the plurality of polygons and the Bezier curves into texture space, constructing an implicit signed distance function based on the assigned texture coordinates and the Bezier curve function, determining for each pixel within each of the plurality of polygons, based on the implicit signed distance function, whether the pixel is located inside or outside the respective Bezier curve, and shading the pixels determined to be inside the Bezier curve.

### BACKGROUND OF INVENTION

1. Field of the Invention

The present invention relates generally to a system and method for rendering an image using Bezier curves. More specifically, the present invention relates to a system and method for rendering a resolution-independent image using Bezier curves and an implicit signed distance function.

2. Background Art

Computer graphics systems are designed to facilitate graphical representations of objects on a computer screen. As is known in the art, parametric Bezier curves may be used in such systems to mathematically generate smooth curves based on a given number of control points. A Bezier curve of degree n may be mathematically represented in terms of Bernstein polynomials as

$$B ( t ) = {\sum }_{i = 0}^{n} ( \begin{matrix}n \\ i\end{matrix} ) {( 1 - t )}^{n - 1} {t}^{i} {P}_{i} ,$$

where

$$( \begin{matrix}n \\ i\end{matrix} )$$

is the binomial coefficient

$$\frac{n !}{( n - 1 ) ! i !}$$

and tε[0, 1]. Points P₀ . . . Pᵢ are the control points.

A Bezier curve of degree n has n+1 control points, which form a control polygon with at least n vertices. For example, a linear Bezier curve has two control points and is represented as B(t)=P₀+t(P₁−P₀), a quadratic Bezier curve has three control points and is represented as B(t)=(1−t)²P₀+2(1−t)tP₁+t²P₂, and so forth. FIG. 1A shows an example of a quadratic Bezier curve having control points P₀, P₁, and P₂, and FIG. 1B shows an example of a cubic Bezier curve having control points P₀, P₁, P₂, and P₃.

Every point along a Bezier curve is a convex combination of the control points, meaning that the curve is completely contained within the convex hull of the control points. Bezier curves allow smooth curves to be drawn mathematically with only a select number of data points. In modern computer graphics system, Bezier curves are rendered through a graphics processing unit (GPU), which is a processor dedicated for rendering graphics. For example, a GPU is commonly used for computing three-dimensional graphics functions.

### SUMMARY OF INVENTION

In general, in one aspect, the invention relates to a method for resolution-independent rendering of an image defined at least in part by a Bezier curve function. The method includes subdividing the image into a plurality of polygons based on Bezier control points of the Bezier curve function, each of the polygons being defined around a Bezier curve, assigning texture coordinates to the Bezier control points, projecting the plurality of polygons and the Bezier curves into texture space, constructing an implicit signed distance function based on the assigned texture coordinates and the Bezier curve function, determining for each pixel within each of the plurality of polygons, based on the implicit signed distance function, whether the pixel is located inside or outside the respective Bezier curve, and shading the pixels determined to be inside the Bezier curve.

In general, in another aspect, the invention relates to a computer system for resolution-independent rendering of an image defined at least in part by one or more Bezier curves. The computer system includes a processor; a graphics processing unit (GPU); storage device; and computer-readable instructions stored in the storage device executable on the processor and the GPU for causing the computer system to perform: subdividing the image into a plurality of polygons based on Bezier control points of the Bezier curve function, each of the polygons being defined around a Bezier curve; assigning texture coordinates to the Bezier control points; projecting the plurality of polygons and the Bezier curves into texture space; constructing an implicit signed distance function based on the assigned texture coordinates and the Bezier curve function; determining for each pixel within each of the plurality of polygons, based on the implicit signed distance function, whether the pixel is located inside or outside the respective Bezier curve; and shading the pixels determined to be inside the Bezier curve.

In general, in another aspect, the invention relates to a program for resolution-independent rendering of an image defined at least in part by one or more Bezier curves stored on a non-transitory computer-readable medium. The program includes computer-readable instructions stored in the non-transitory computer-readable medium for causing a computer to perform: subdividing the image into a plurality of polygons based on Bezier control points of the Bezier curve function, each of the polygons being defined around a Bezier curve; assigning texture coordinates to the Bezier control points; projecting the plurality of polygons and the Bezier curves into texture space; constructing an implicit signed distance function based on the assigned texture coordinates and the Bezier curve function; determining for each pixel within each of the plurality of polygons, based on the implicit signed distance function, whether the pixel is located inside or outside the respective Bezier curve; and shading the pixels determined to be inside the Bezier curve.

Other aspects and advantages of the invention will be apparent from the following description and the appended claims.

### BRIEF DESCRIPTION OF DRAWINGS

FIG. 1A shows an example of a quadratic Bezier curve and FIG. 1B shows an example of a cubic Bezier curve.

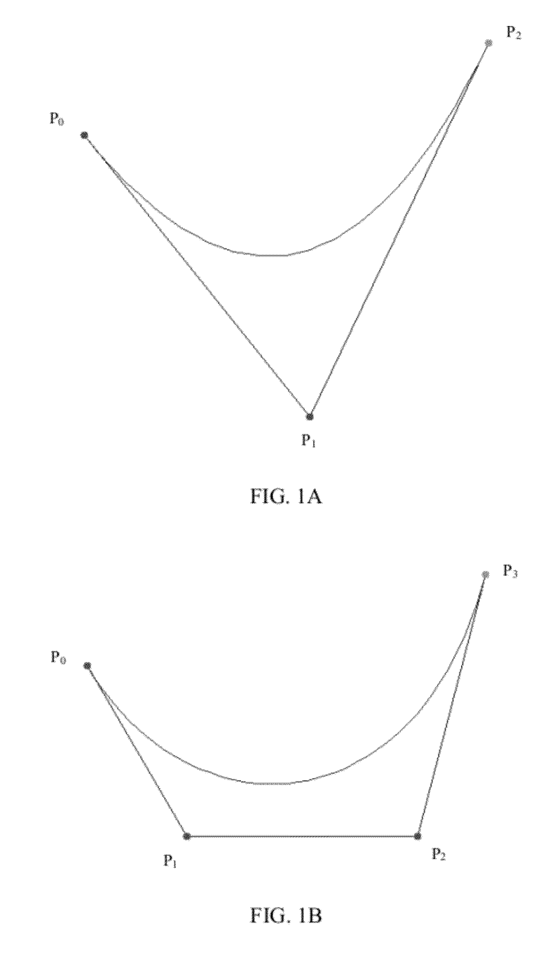

FIG. 2 shows an exemplary flowchart of resolution-independent rendering of images in accordance with one or more embodiments of the present invention.

FIG. 3 shows an example of a polygon in accordance with one or more embodiments of the present invention.

FIGS. 4A and 4B show an exemplary process for determining an implicit signed distance function in accordance with one or more embodiments of the present invention.

FIG. 5 shows a pixel-shader screenshot of an image rendered in accordance with one or more embodiments of the present invention.

FIG. 6 shows a computer system in accordance with one or more embodiments of the present invention.

### DETAILED DESCRIPTION

Exemplary embodiments of the invention will be described with reference to the accompanying figures. Like items in the figures are shown with the same reference numbers.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In general, the present invention relates to a system and method for developing resolution-independent Bezier curves on a computer graphics system. More specifically, one or more embodiments of the present invention allow for resolution-independent rendering of images using Bezier curves and an implicit signed distance function. The implicit signed distance function calculates the distance between a given point and the Bezier curve, and indicates whether the point lies inside or outside the Bezier curve. Further, according to one or more embodiments of the present invention, the implicit signed distance function corresponding to the Bezier curves allows for direct mapping of picture elements (pixels) to texture space, i.e., a two-dimensional coordinate system corresponding to point(s) on a texture. The control points of the Bezier curve are also mapped to texture space. As known in the art, texture mapping is a method for adding texture details (e.g., color, shades, reflection, surface irregularities, etc.) to a computer-generated image.

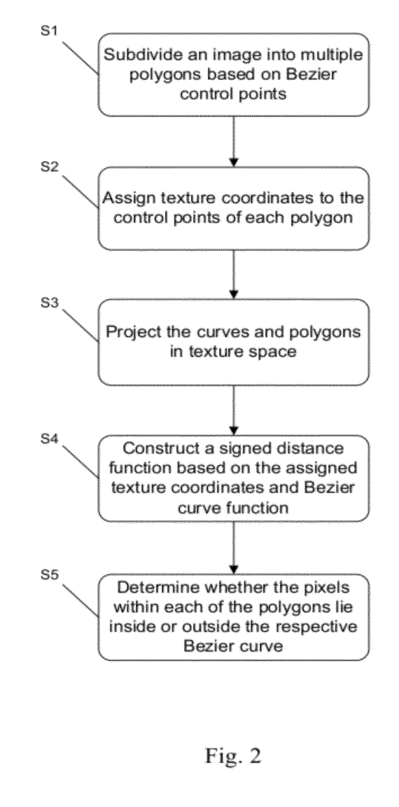

FIG. 2 shows the general steps involved for resolution-independent rendering of an image that is defined, at least in part, by Bezier curves in accordance with one or more embodiments of the present invention. First, in Step S1, an image is broken down or subdivided into multiple polygons based on Bezier control points, such that each of the polygons is defined around a Bezier curve. The image is defined at least in part by a Bezier curve function, represented in terms of Bernstein polynomials

$$B ( t ) = {\sum }_{i = 0}^{n} ( \begin{matrix}n \\ i\end{matrix} ) {( 1 - t )}^{n - 1} {t}^{i} {P}_{i} .$$

The Bezier control points define the Bezier curves, which in turn define at least an outline of the image. In one or more embodiments, the polygons may be formed by applying known algorithms (e.g., triangulation algorithms) to the Bezier control points.

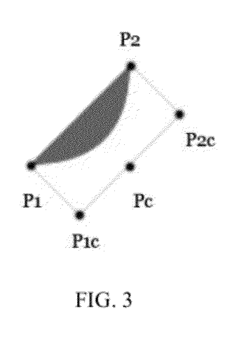

In one or more embodiments of the present invention, the Bezier curves may be quadratic Bezier curves, each of which is defined by three control points. Additional points may also be mapped to complete a desirable polygon (triangle, rectangle, etc.). For example, in one or more embodiments, a rectangle can be used as shown in FIG. 3. The control points are denoted as P₁, P_{c}, and P₂. Additional points P_{1c} and P_{2c} are used to complete the rectangular geometry, which provides additional room for handling anti-aliasing near the edges of the Bezier curve boundaries.

In step S2, texture coordinates [u, v] are assigned to the above-mentioned points for each of the polygons, and in step S3, the Bezier curves and polygons are projected in texture space. For example, as shown in FIG. 2, the texture coordinates of the points P₁, P_{1c}, P_{c}, P_{2c}, and P₂ may be assigned, respectively, as [0.0, 0.0], [0.0, 1.0], [0.5, 1.0], [1.0, 1.0], and [1.0, 0.0]. The assignment of the texture coordinates may be based on a mathematical function of the object coordinates or manually assigned.

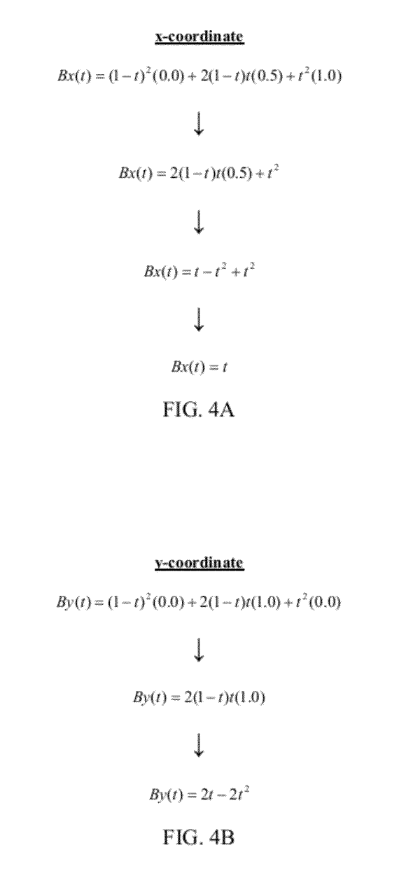

Next, in Step S4, an implicit signed distance function is constructed based on the assigned texture coordinates and the Bezier curve function. In one or more embodiments, the implicit signed distance function may be found using the quadratic Bezier curve function B(t)=(1−t)²P₁+2(1−t)tP_{c}+t²P₂, where parameter t=[0 . . . 1]. The implicit signed distance function, the zero set of which defines the image, may be used by a GPU to determine which points within the polygons are inside or outside their respective Bezier curve. Further, in one or more embodiments, the implicit signed distance function may be found by substituting in the aforementioned texture coordinates for the control points P₁, P_{c}, and P₂ and reducing the Bezier function as shown in FIGS. 4A and 4B.

The value of the implicit signed distance function indicates the distance between a given point and the Bezier curve. As can be seen from FIG. 4A, the distance is always zero for the x-coordinate because Bx(t)=t. On the other hand, as shown in FIG. 4B, the distance for the y-coordinate can be reduced to a simple quadratic function, whose distance for point P(x, y) is given by y−(2x−2x²). Thus, in one or more embodiments, the implicit signed distance function may be represented as f(u, v)=u−(−2v²+2v). The sign of the implicit signed distance function indicates whether a pixel within the polygon belongs inside or outside the Bezier curve.

Once the implicit signed distance function is obtained, a determination is made of whether the pixels within each of the polygons lie inside or outside the respective Bezier curve. A GPU-executable shader program (e.g., pixel shader) may be used to evaluate each of the pixels within each of the polygons based on the explicit representation of the implicit signed distance function (Step S5). For example, for each of the polygons, the shader program may interpolate the texture coordinates [u, v] across the domain [0, 0] and [1, 1] and shade only the pixels located inside (or, depending on the viewer's perspective, outside) the Bezier curve of the polygon.

Although a rectangular geometry is used for purposes of illustration, the implicit signed distance function may be implemented with other polygons. Furthermore, those skilled in the art will appreciate that one or more of the above-described steps may be performed in different orders or in parallel.

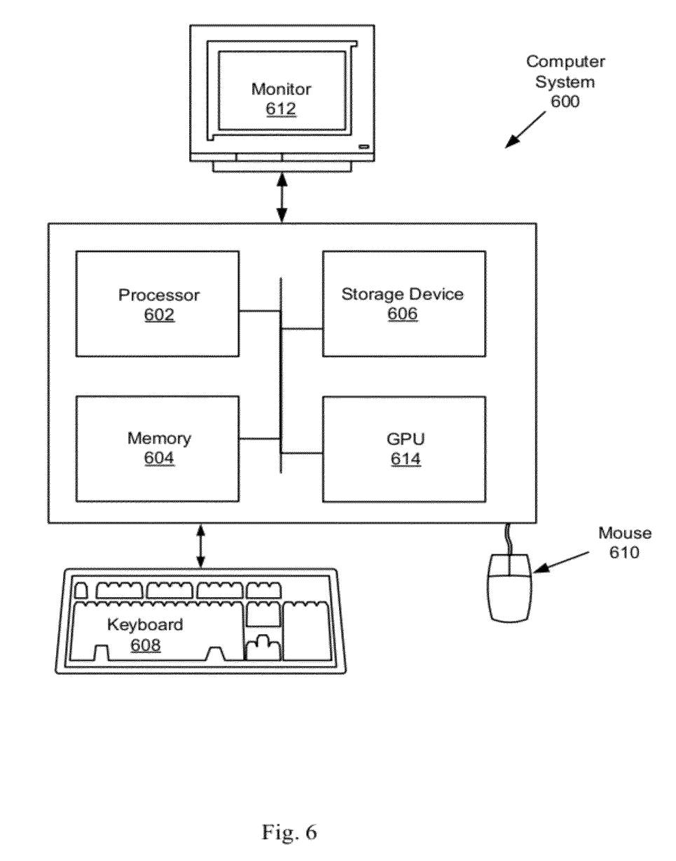

One or more embodiments of the present invention may be implemented on any type of computer system equipped with a GPU. For example, as shown in FIG. 6, a computer system 600 includes a processor 602, associated memory 604, a storage device 606, GPU 614, and numerous other elements and functionalities typical of today's computers (not shown). The memory 604 may include instructions executable by the processor 602 and GPU 614 for causing the system 600 to perform image-rendering techniques in accordance with one or more embodiments.

The computer system 600 may also include input means, such as a keyboard 608 and a mouse 610, and output means, such as a monitor 612. The computer system 600 is connected to a local area network (LAN) or a wide area network (e.g., the Internet) (not shown) via a network interface connection (not shown). Those skilled in the art will appreciate that these input and output means may take other forms, now known or later developed.

Further, those skilled in the art will appreciate that one or more elements of the aforementioned computer system 600 may be located at a remote location and connected to the other elements over a network. Further, one or more embodiments may be implemented on a distributed system having a plurality of nodes, where one or more elements may be located on a different node within the distributed system. In one or more embodiments, the node corresponds to a computer system. Alternatively, the node may correspond to a processor with associated physical memory. The node may alternatively correspond to a processor with shared memory and/or resources. Further, software instructions to perform embodiments of the invention may be stored on a tangible, non-transitory computer-readable medium such as a digital video disc (DVD), compact disc (CD), a diskette, a tape, or any other suitable computer-readable storage device.

Embodiments of the claimed invention may provide one or more of the following advantages.

The implicit signed distance function in accordance with one or more embodiments of the present invention can accurately determine whether each pixel of an image defined at least in part by Bezier control points is located inside or outside the Bezier curves. As a result, embodiments of the present invention can render high-quality, resolution-independent images. Further, by performing most of the graphics computations on a GPU, embodiments of the present invention can reduce the load on the central processing unit (CPU) when rendering the curves. Thus, overall system efficiency is improved.

Further, the implicit signed distance function in accordance with one or more embodiments can be centered around the curve, making it suitable to handle both convex and concave hulls. Further, the implicit signed distance function in accordance with one or more embodiments provides a basis for calculating anti-aliasing values of the pixels on either side of the curve.

Further still, image-rendering techniques in accordance with one or more embodiments of the present invention can cover more geometry for a given geometric primitive and calculate the position of the pixels with better accuracy. One or more embodiments of the present invention also provide simplicity over conventional methods. For example, the implicit signed distance function can be determined without relying on complex computations involving gradients or vector calculus, which saves processing resources and improves system efficiency.

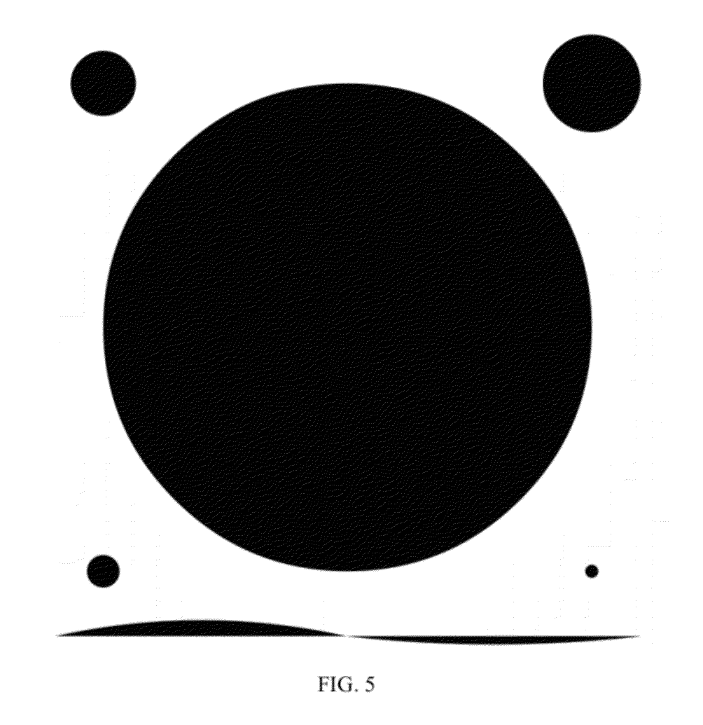

One or more embodiments of the present invention may be implemented in a variety of methods and software environments. Shown below is one source code example implemented using an OpenGL Shader program. FIG. 5 is an example screenshot of an image rendered by the code below.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for resolution-independent rendering of an image defined at least in part by a Bezier curve function, the method comprising:
subdividing the image into a plurality of polygons based on Bezier control points of the Bezier curve function, each of the polygons being defined around a Bezier curve;
assigning texture coordinates to the Bezier control points;
projecting the plurality of polygons and the Bezier curves into texture space;
constructing an implicit signed distance function based on the assigned texture coordinates and the Bezier curve function;
determining for each pixel within each of the plurality of polygons, based on the implicit signed distance function, whether the pixel is located inside or outside the respective Bezier curve; and
shading the pixels determined to be inside the Bezier curve.

2. The method according to claim 1, wherein the implicit signed distance function is constructed by substituting the assigned texture coordinates into the Bezier curve function.

3. The method according to claim 2, wherein the Bezier curves are quadratic Bezier curves and the assigned texture coordinates of the Bezier control points are [0.0, 0.0], [0.5, 1.0], and [1.0, 0.0].

4. The method according to claim 3, wherein the implicit signed distance function is represented as f(u, v)=u−(−2v²+2v).

5. The method according to claim 1, wherein the shading comprises interpolating the texture coordinates using a GPU-executable shader program.

6. The method according to claim 1, further comprising applying anti-aliasing to the image based on the implicit signed distance function.

7. A computer system for resolution-independent rendering of an image defined at least in part by one or more Bezier curves, the computer system comprising:
a processor;
a graphics processing unit (GPU);
storage device; and
computer-readable instructions stored in the storage device executable on the processor and the GPU for causing the computer system to perform:
subdividing the image into a plurality of polygons based on Bezier control points of a Bezier curve function, each of the polygons being defined around a Bezier curve;
assigning texture coordinates to the Bezier control points;
projecting the plurality of polygons and the Bezier curves into texture space;
constructing an implicit signed distance function based on the assigned texture coordinates and the Bezier curve function;
determining for each pixel within each of the plurality of polygons, based on the implicit signed distance function, whether the pixel is located inside or outside the respective Bezier curve; and
shading the pixels determined to be inside the Bezier curve.

8. The computer system according to claim 7, wherein the implicit signed distance function is constructed by substituting the assigned texture coordinates into the Bezier curve function.

9. The computer system according to claim 8, wherein the Bezier curves are quadratic Bezier curves and the assigned texture coordinates of the Bezier control points are [0.0, 0.0], [0.5, 1.0], and [1.0, 0.0].

10. The computer system according to claim 9, wherein the implicit signed distance function is represented as f(u, v)=u−(−2v²+2v).

11. The computer system according to claim 7, wherein the shading comprises interpolating the texture coordinates using a GPU-executable shader program.

12. The computer system according to claim 7, wherein the computer-readable instructions further causes the computer system to perform applying anti-aliasing to the image based on the implicit signed distance function.

13. A program for resolution-independent rendering of an image defined at least in part by one or more Bezier curves stored on a non-transitory computer-readable medium, the program comprising:
computer-readable instructions stored in the non-transitory computer-readable medium for causing a computer to perform:
subdividing the image into a plurality of polygons based on Bezier control points of a Bezier curve function, each of the polygons being defined around a Bezier curve;
assigning texture coordinates to the Bezier control points;
projecting the plurality of polygons and the Bezier curves into texture space;
constructing an implicit signed distance function based on the assigned texture coordinates and the Bezier curve function;
determining for each pixel within each of the plurality of polygons, based on the implicit signed distance function, whether the pixel is located inside or outside the respective Bezier curve; and
shading the pixels determined to be inside the Bezier curve.

14. The program according to claim 13, wherein the implicit signed distance function is constructed by substituting the assigned texture coordinates into the Bezier curve function.

15. The program according to claim 14, wherein the Bezier curves are quadratic Bezier curves and the assigned texture coordinates of the Bezier control points are [0.0, 0.0], [0.5, 1.0], and [1.0, 0.0].

16. The program according to claim 15, wherein the implicit signed distance function is represented as f(u, v)=u−(−2v²+2v).

17. The program according to claim 13, wherein the shading comprises interpolating the texture coordinates using a GPU-executable shader program.

18. The program according to claim 13, wherein the computer-readable instructions further cause the computer to perform applying anti-aliasing to the image based on the implicit signed distance function.
